(19) United States
(12) Patent Application Publication
(10) Pub. No.: US 2008/0137365 A1
(43) Pub. Date: Jun. 12, 2008

(54) Lighting Fitting

(76) Inventor: Krzysztof Skiba, Bielsko-Biala (PL)

Correspondence Address: POWER DEL VALLE LLP, 233 WEST 72 STREET, NEW YORK, NY, 10023, US

(21) Appl. No.: 11/815,129

(22) PCT Filed: Jan. 31, 2006
(86) PCT No.: PCT/PL06/00008

§ 371 Date: Jul. 31, 2007

(30) Foreign Application Priority Data
Feb. 2, 2005 (PL) P372550

(51) Int. Cl. F21V 8/00

(52) U.S. Cl. 362/606

(57) ABSTRACT

The object of the invention is the lighting fitting using LED-based source of C light, applied for constructing functional frames, backlighting stair treads and stair risers, furniture shelves, backlighting current connectors and lighting traffic routes in buildings and structures. The lighting fitting is supplied by an electrical system and it has a casing (1) with one side open with a source of light (2) placed inside it. On the side of the casing (1) opening, there is an optical fibre element (4) in the form of a shaped plate whose at least two edges (3) and (7) transmit the luminous flux, with one on the side of the light source (2), similarly as the front wall (5) of the optical fibre element (4), while the back wall (6) of the optical fibre element (4) is partly or wholly matted or covered with a light reflecting material or fluorescent material.

The object of the invention is the lighting fitting using LED-based source of light, applied for constructing functional frames, backlighting stair treads and stair risers, furniture shelves, backlighting current connectors and lighting traffic routes in buildings and structures.

There is known a Polish patent application no. P-364017 for a lighting clip fixed around an edge of a transparent or semi-transparent panel in a removable or permanent way and supplied by an electric power system. The clip is in the form of a section, with at least one open side, consisted of clamping arms connected with a connector and provided with at least one source of light from the inside. The section is in the form of a self-supporting elastic shape, with at least one open side, built of clamping arms of different length, where one of the arms is diagonal to the external panel surface or the section is in the form of a self-supporting elastic shape, with at least one open side, built of clamping arms of equal length, where both arms are diagonal to the panel surface, or the section is in the form of a shape, open on one side, which consists of two clamping arms which are parallel.

There is known a Polish patent application no. P-371391 for a lighting fitting used for backlighting, from inside surfaces, transparent or semi-transparent materials in the form of glass or plastic panes, especially glass shelves in shelf units or glass table and desk tops. The lighting fitting is supplied by an electric power system and it has an internal ring on its both sides provided with covers of external diameter bigger than the external diameter of the ring, where there is at least one source of light, preferably in the form of LED elements, on the external side surface of the internal ring. Preferably, external surfaces of the covers are parallel and preferably they are in the form of cylindrical discs or cylindrical discs where covers and the internal ring are provided with a passage in their central part or one of the covers is in the form of a supporting unit or both covers are in the form of a supporting unit.

The lighting fitting, supplied by an electrical system, according to the invention is characterised by the fact that it has a casing with one side open with a source of light placed inside it and, on the side of the casing opening, there is an optical fibre element in the form of a shaped plate, preferably with two parallel surfaces forming the front and back wall, whose at least two edges transmit the luminous flux, with one on the side of the light source, similarly as the front wall of the optical fibre element, while the back wall of the optical fibre element is partly or wholly matted or covered with a light reflecting material or fluorescent material. The edge of the optical fibre element is perpendicular, diagonal, semicircular or shape-ended in relation to the back wall of the optical fibre element.

The object of the invention has been presented as an example product in the drawing, where

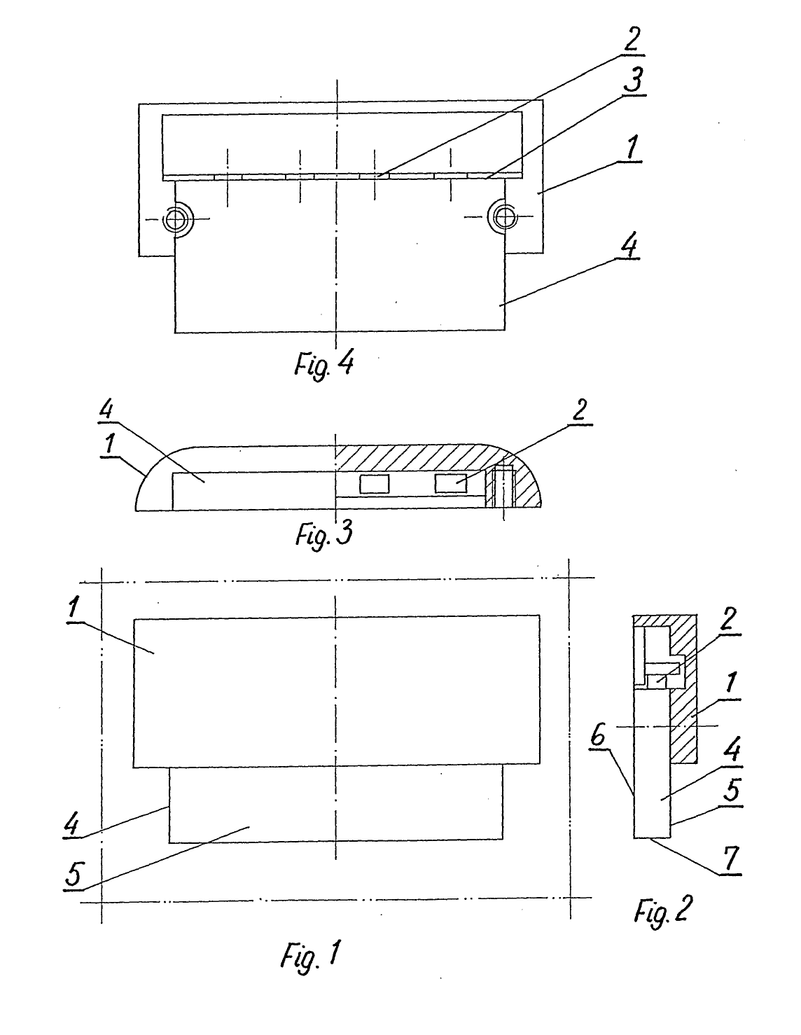

FIG. 1 presents a front view of the lighting fitting,

FIG. 2 presents a cross section of the lighting fitting,

FIG. 3 shows half-view of the lighting fitting seen from the side of the optical fibre element and its half-section seen from the side with a source of light,

FIG. 4 presents the lighting fitting seen from its fixing side,

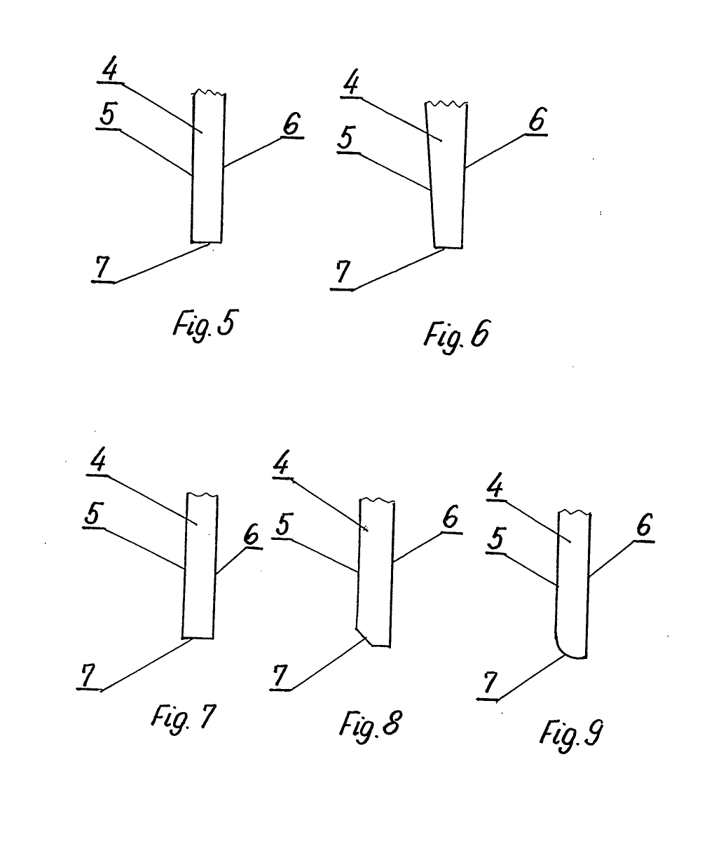

FIG. 5 presents a side view of the shape of walls of the optical fibre element with parallel walls,

FIG. 6 shows a side view of walls of the optical fibre element with diagonal walls;

FIG. 7 presents a side view of the shape of the bottom straight edge of the optical fibre element,

FIG. 8 presents a side view of the shape of the bottom diagonal edge of the optical fibre element, and

FIG. 9 shows a side view of the shape of the bottom shaped edge of the optical fibre element.

As it has been presented in the drawing, the lighting fitting is supplied by an electrical system and it consists of an open casing 1, with a source of light 2 placed inside it. A source of light is preferably in the form of LED elements which are situated along one edge 3 of the optical fibre element 4, pervious to the source of light, where that element is placed on the open side of the casing 1. The optical fibre element 4 is in the form of a shaped plate, preferably with two parallel surfaces that form the front wall 5 and the back wall 6, whose at least two edges 3 and 7 transmit the luminous flux, similarly as the front wall 5 of the optical fibre element 4, while the back wall 6 of the optical fibre element 4 is partly of wholly matted or covered with a light reflecting material or fluorescent material. The edge 7 of the optical fibre element 4 is perpendicular, diagonal, semicircular or shape-ended in relation to the back wall 6 of the optical fibre element 4.

1. The lighting fitting, supplied by an electrical system, characterised by the fact that it has a casing (1) with one side open with a source of light (2) placed inside it and, on the side of the casing (1) opening, there is an optical fibre element (4) in the form of a shaped plate, preferably with two parallel surfaces forming the front wall (5) and the back wall (6), whose at least two edges (3) and (7) transmit the luminous flux, with one on the side of the light source (2), similarly as the front wall (5) of the optical fibre element (4), while the back wall (6) of the optical fibre element (4) is partly or wholly matted or covered with a light reflecting material or fluorescent material.

2. The lighting fitting, according to claim 1, characterised by the fact that the edge (7) of the optical fibre element (4) is perpendicular, diagonal, semicircular or shape-ended in relation to the back wall (6) of the optical fibre element (4).
